(19) United States
(12) Patent Application Publication
(10) Pub. No.: US 2017/0303358 A1
(43) Pub. Date: Oct. 19, 2017

(54) A Smart Lighting System

(71) Applicant: Diodes Incorporated, Plano, TX (US)

(72) Inventor: Adrian Wang, San Jose, CA (US)

(73) Assignee: Diodes Incorporated, Plano, TX (US)

(21) Appl. No.: 15/509,551

(22) PCT Filed: Sep. 30, 2014
(86) PCT No.: PCT/US2014/058217

§ 371 Date: Mar. 8, 2017

(51) Int. Cl. H05B 33/08

(52) U.S. Cl. CPC H05B 33/0845; H05B 33/0827

(57) ABSTRACT

A multiple channel current regulator is configured to deliver a maximum current to a load associated with the channel in a lighting system. Different channels may have a different maximum current and the ratio among the maximum currents is fixed. In operation, the current of each channel can be individually modulated by a pulse stream that controls the current that flows to the load.

### BACKGROUND

Multi-channel current regulators are traditionally designed to source or sink identical or similar current at each channel at its maximum. This approach is reasonable for applications where loading is evenly distributed to the channels.

There are, however, applications where the current requirement for each channel is different. In these occasions, this approach of designing current regulator is inadequate. For example, when the current regulator is used to drive multiple strings of LED of different colors, especially when each channel is subject to tuning by a dimmer, the traditional current regulator design is wasteful, costly, and difficult to incorporate into “smart-lighting” systems.

The cause of this deficiency is that due to the difference in human sensation to lights of different colors, the lumens from different colored LEDs that are optimal in color mixes are different. For example, it takes fewer lumens for blue light to mix with green and red lights to generate a discernible white color light of various color temperatures. If the channel for driving the green light is designed for the same current capability, the blue channel is often over-designed and less energy efficient.

A more serious deficiency is that when incorporated into a smart lighting system, such a current regulator makes the system performance inferior in another aspect. That is, in a system of correlated color temperature (CCT) tunable or color tunable, for example, it is desirable if each channel is separately tunable from maximum lumens to minimum lumens and with high resolution. With traditional multichannel power supplies in which all channels have identical or similar peak current capability, the channels that do not require to deliver up to their maximum capacity will have un-used current head room that is not subject to tuning in normal operation. The tuning circuit, on the other hand, is often designed for the whole current range to be compatible to the rest of the lighting system. The apparent dynamic range for the channels that are over-designed will be poor. As a result, the system dynamic range will be poor. This problem is not generally recognized and is not solved before this invention.

### SUMMARY

The Inventor recognized the shortcomings of the current smart-lighting system and endeavored to invent solutions, which are disclosed in this paper and are summarized below.

One aspect of the invention relates to a multiple channel current regulator that is configured so each channel is capable to deliver a maximum current to a load but different channels may have a different maximum current and the ratio among the maximum currents is fixed. For example, in a four channel current regulator designed for a smart lighting system, the maximum currents of the four channels follow the ratio of 1:1:0.75:0.25.

In this paper, the maximum current is to be understood as the current that a channel can source or sink with enough operational margins that the product and the system in which the product is incorporated can function safely. The current flowing in each channel may exceed the maximum value for a short time but for reliable and safe operation, this practice is not recommended.

The multichannel current regulator may be realized in the form of an integrated circuit. Currently, silicon is the favored material for making integrated circuits but other semiconductor materials such as silicon carbide, gallium nitride, and gallium arsenide, etc. are also contemplated.

Unless otherwise noted, all embodiments described in the paper are products with manufacturing limitations and therefore any number associated with the embodiments is to be treated as having the usual industry tolerances. For instance, a ratio of 1:1 in this paper is to be understood to mean a ratio that is close to be mathematical 1:1 as to be commercially acceptable for LED lighting systems.

Another aspect of the invention is that the maximum current of each channel may be adjusted but the adjustment does not disturb the ratio among the channels, which remains fixed.

Although it is contemplated that, for flexibility, the maximum current of each channel be adjustable individually, it is more economical to adjust the maximum currents of all channels with a common mechanism so the ratio among the maximum currents after the adjustment stays undisturbed.

Another aspect of the invention is that while the ratio of the maximum currents is fixed, the actual current of each channel may be adjusted independently through modulation.

One method with which the current may be modulated is with pulse width modulation (PWM). With this method, the current that flows into or from a LED light source in some embodiments is allowed to flow when a switching apparatus is open and is restricted when it is closed. The amount of current during a discernible time period, or the amount of light that is emitted from the light source during the time period is modulated by the varying duty cycles of a pulse stream that operates the switching apparatus.

Other methods that may be employed to modulate the current flow at the channels include pulse frequency modulation, with which the pulse stream maintains a constant duty cycle but the frequency of the pulse stream varies.

A voltage or a current pulse stream is made of consecutive pulses, each of which has a high level and a low level. The duty cycle of a pulse is the ratio of the duration when the pulse is at its high level to the duration when the pulse is at it low level.

Another aspect of the invention is a current regulator, which may be constructed in one single integrated circuit. Although in most applications, a single chip multichannel current regulator may suffice, for capacity consideration, multiple chips may be incorporated into a system.

Another aspect of the invention is that the current regulator is dimmable via either a digital diming signal or an analog diming signal. For economical consideration, it is more desirable to convert an analog dimming signal into a digital pulse stream, to modulate the current flow at each channel.

### BRIEF DESCRIPTION OF DRAWINGS

FIG. 1 depicts the block diagram of an example current regulator according to the invention.

FIG. 2 depicts a typical smart lighting system that incorporates the example current regulator depicted in FIG. 1.

### DETAILED DESCRIPTION

### Example 1

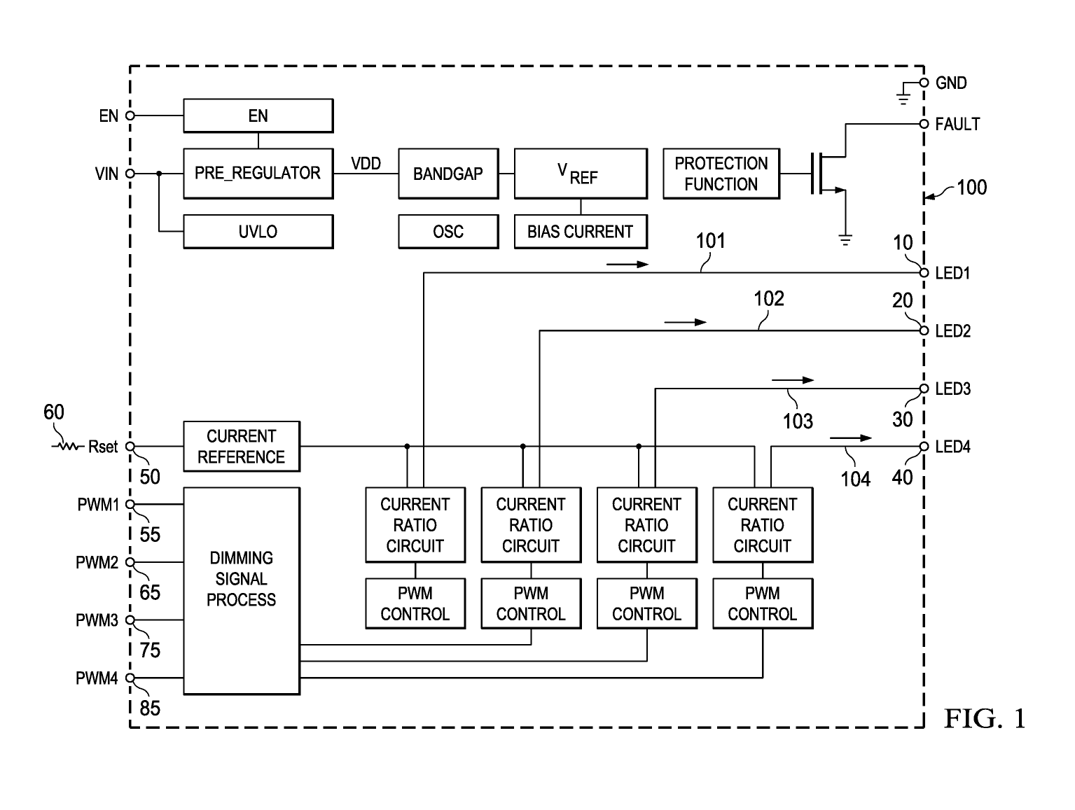

FIG. 1 depicts the block diagram of an example current regulator 100 that embodies several aspects of this invention. The example current regulator 100 is a four-channel ratio-optimized constant-current regulator built for Tunable White and Tunable Color Smart Lighting applications. Other current regulators embodying this invention may have more or fewer than four channels. For example, a current regulator embodying this invention may have two or three channels. The current regulator 100 is designed for maximum current channel up to 500 mA with a total driving current up to 1.5 A. This particular driving current is picked for illustration because it serves a wide range of smart-lighting applications. The integrated low-side current sinks in this design allow for LED common-anode connections or different anode voltages.

The current ratio among the channels is predetermined for Tunable Color or Tunable White applications. The maximum current can be adjusted via a resistor 60, which may be external to the current regulator 100, which may be constructed in a single integrated circuit (IC) chip. The resistor 60 may be coupled directly at terminal R_{SET} 50 of the IC chip. The maximum currents at channel 1, I1 101, channel 2, I2 102, channel 3, I3 103, and channel4, I4 104 that flow to the output terminals Pin1 10, Pin2 20, Pin3 30, and Pin4 40 respectively may be expressed according the following formulae:

Iₘₐₓ₁=2000*V_{REF}/R_{SET}

Iₘₐₓ₂=2000*V_{REF}/R_{SET}

Iₘₐₓ₃=1500*V_{REF}/R_{SET}

I_{MAX4}=500*V_{REF}/R_{SET}

where V_{REF}=1.5 V

For example, for a fixed V_{REF}, with an R_{SET} resistor 60 set at 12 KΩ, channel 1, 2, 3, and 4 can provide maximum current of 250 mA, 187.5 mA, 250 mA, and 62.5 mA respectively. With a different valued R_{SET} resistor 60, one may adjust the maximum current for channel 1 through channel 4 to different values. The ratio among the maximum currents, however, will be maintained at the same predetermined. In applications, two or more channels may be tied together to drive one LED light source with the aggregated current.

The current regulator 100 is designed to incorporate a dimming function through pulse width modulation. Other methods of modulating the currents for the dimming purpose such as pulse frequency modulation and analog dimming are also contemplated. Dimming signals are coupled to the PWM (PWM1 55, PWM2 65, PWM3 75, and PWM4 85) pins of the IC chip. In this example, the current regulator 100 is configured, during startup, to operate in PWM dimming mode at a PWM frequency ranging, for example, from 500 Hz to 4 KHz. In this mode, high level of the PWM signals will turn on the current sink to allow current to flow through the LEDs and low level of the PWM signals will turn the current off to adjust the LED current and LED brightness of each corresponding channel.

### Example 2

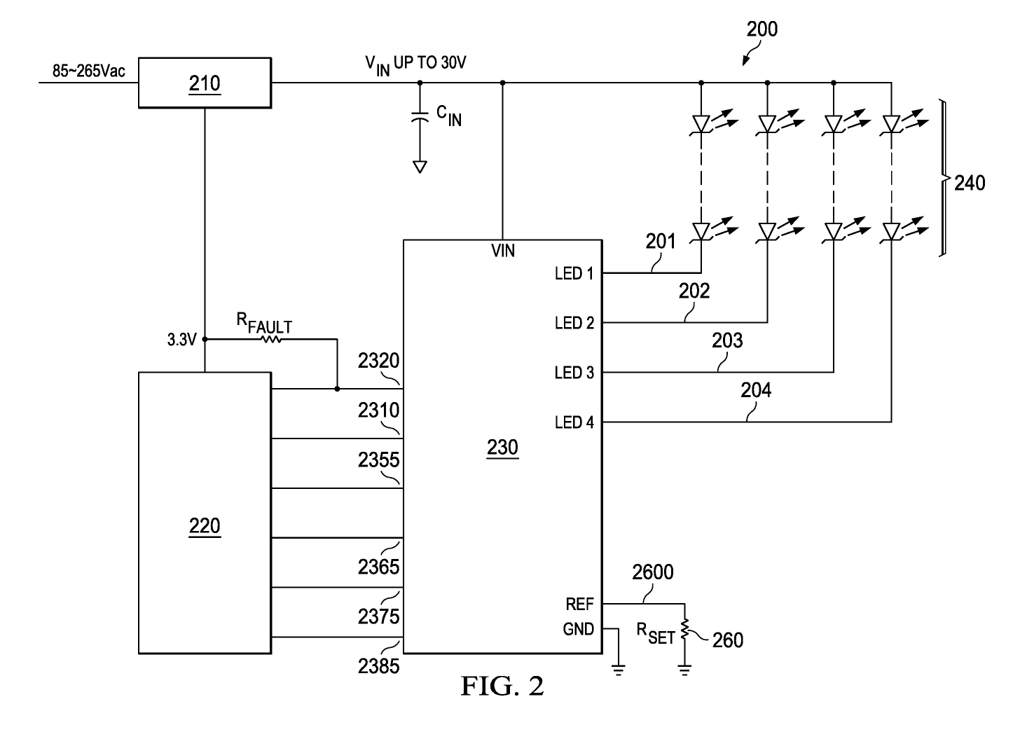

In another embodiment of this invention, a smart LED lighting system can use either wired or wireless control to achieve energy efficient lighting management. FIG. 2 depicts a block diagram of an example smart lighting system 200 embodying aspects of this invention. The lighting system 200 comprises an AC to DC power conversion unit 210, a color management MCU 220, a LED current regulator 230, and light emitting diodes 240.

The AC to DC Power Conversion unit 210 provides constant voltages (CV) to power the MCU 220, the LED current regulator 230, and the light emitters 240. This typical smart lighting system 200 requires 3.3 V supply for MCU 220 and 12 V/24 V for High-Power/Low-Power LED light source 240.

The interface between MCU 220 and the current regulator 230 includes an Enabling signal 2310, pulse width modulation signals PWM1 2355, PWM2 2365, PWM3 2375, PWM4 2385, and FAULTB signal 2320. The MCU 220 activates the EN signal 2310 to turn on the current regulator 230 to power the LED light sources 240. When EN 2310 pin is low the current regulator 230 shuts down to conserve energy. MCU 220 implements light mixing algorithm and generates proper PWM signals through PWM pins 2355-2385. In case of any general fault occurs in the current regulator 230, a FAULTB signal 2310 goes low to interrupt MCU 220 for proper actions.

The current regulator 230 is configured to a four-channel LED driver structure and can adopt either analog or PWM dimming control for each channel. The four parallel LED driver channel structure is configured for applications of either Tunable White (2-channel or 3-channel) or Tunable Color (3-channel, or 4-channel). The system depicted in FIG. 2 supports a LED light source 240 of up to 8 LEDs of White, Blue, Green or 10 LEDs of Red in series and can deliver between 600 to 1,200 lumens of illumination.

A reference current may be set by a resistor 260 that is external to the current regulator 230. With a 12 KΩ resistor 260, the reference current at the REF pin 2600 may be set at 0.125 mA. Because the Tunable White or Tunable Color applications use unequal amount of colored light lumens, the current regulator 230 adopts a current ratio of 1:0.75:1:0.25 among the four channels. This current ratio results in a more efficient use of the chip size of the current regulator 230. Through internal current ratio circuitries such as current mirrors, the maximum current of channel 1, 2, 3 and 4 may be set at 250 mA, 250 mA, 187.5 mA and 62.5 mA, respectively. The actual current through each emitter string may be further modulated by a dimming mechanism.

### Example 3

In an embodiment of this invention, referring FIG. 2, a Tunable White light system for tuning the white color temperature based on two LED channels may be realized by using LED1 201 and LED2 202 to provide equal current through each channel and using PWM1 and PWM2 signals 2355, 2365 generated by MCU to emulate incandescent dimming effects. To further enhance the quality of CCT diming, one may use either I3 203 (ratio 0.75) or I4 204 (ratio 0.25) with proper modulation to provide finer CCT adjustments.

### Example 4

In another embodiment of this invention, as depicted in FIG. 1, a Tunable Color light system for tuning lighting color may be realized by using three LED channels to mix red, green, and blue colors to generate white light. The proper GRB color mixes ratio for white light is 8:6:2, which is the current ratio in the example current regulator 100, among I2 10, I3 20, and I4 30 as depicted in FIG. 1. With PWM signals generated by MCU 220 one may generate desired Tunable White and Color with three RGB LED light sources. To further improve Color Rendering Index (CRI), one may also use LED1 10 (Iₘₐₓ₁ ratio 1) to provide additional White light intensity.

1. An integrated circuit; comprising:
a first current supply circuit connected to a first output pin, configured to output a first maximum current;
a second current supply circuit connected to a second output pin, configured to output a second maximum current; and
the second maximum current less than the first maximum current and being a fixed fraction of the first maximum current.

2. An integrated circuit; comprising:
a first current supply circuit connected to a first output pin, configured to output a first maximum current;
a second current supply circuit connected to a second output pin configured to output a second maximum current;
a third current supply circuit connected to a third output pin configured to output a third maximum current;
a fourth current supply circuit connected to a fourth output pin configured to output a fourth maximum current; and
the fourth maximum current being a fraction a of the third maximum current, a fraction b of the second maximum, and a fraction c of the first maximum current; and a, b, and c not all equal to one.

3. The integrated circuit of claim 2, in which the first current supply circuit is configured to flow to the first output pin an adjustable first current not greater than the first maximum current, the second current supply circuit is configured to flow to the second output pin an adjustable second current not greater than the second maximum current, and the first current and the second current are independently adjustable.

4. The integrated circuit of claim 3, further comprising a first control circuit configured to adjust the first current, and a second control circuit configured to adjust the second current.

5. The integrated circuit of claim 4, in which the first control circuit is configured to send a first pulsed signal to the first current supply circuit to adjust the first current, and the second control circuit is configured to send a second pulsed signal to the second current supply circuit to adjust the second current.

6. The integrated circuit of claim 5, in which the first pulsed signal is adaptable of being adjustable independently from the second pulsed signal.

7. The integrated circuit of claim 6, further comprising a third current supply circuit configured to flow to a third output pin an adjustable third current not greater than the third maximum current, a fourth current supply circuit configured to flow to a fourth output pin an adjustable fourth current not greater than the fourth maximum current.

8. The current regulator of claim 7, further comprising a common current signal coupled to the first, the second, the third, and the fourth current supply circuit, the current signal configured to vary monotonically with respect to a the resistance of a resistor external to the current regulator.

9. A system comprising:
an integrated circuit having a first output pin and a second output pin;
a first LED light source external to the integrated circuit, coupled to the first output pin of the integrated circuit;
a second LED light source external to the integrated circuit, coupled to the first output pin of the integrated circuit;
the integrated circuit including a first current supply circuit and a second current supply circuit, the first current supply circuit configured to flow a first maximum current to the first output pin, the second current supply circuit, configured to flow a second maximum current to the second output pin, and
the first maximum current being greater than the second maximum current.

10. The system of claim 9, further comprising:
a third LED light source external to the integrated circuit, coupled to a third output pin of the integrated circuit;
a fourth LED light source external to the integrated circuit, coupled to a fourth output pin of the integrated circuit;
the integrated circuit further including a third current supply circuit and a fourth current supply circuit, the third current supply circuit configured to flow a third maximum current to the third output pin, the fourth current supply circuit, configured to flow a fourth maximum current to a fourth output pin, and
the fourth maximum current being a fraction a of the third maximum current, a fraction b of the second maximum, and a fraction c of the first maximum current; and a, b, and c not all equal to one.

11. The system of claim 10, further comprising a first control circuit configured to adjust the first current, a second control circuit configured to adjust the second current, a third control circuit configured to adjust the third current, and a fourth control circuit configured to adjust the fourth current.

12. The system of claim 10, further comprising;
a resistor external to the integrated circuit;
a common current signal internal to the integrated circuit; and
is a function of the resistance of the resistor.

13. The system of claim 10, in which the first maximum current, the second maximum current, the third maximum current, and the fourth maximum current vary monotonically with respect to the common current signal.

14. The system of claim 10, in which the fourth maximum current is a third of the second maximum current, and is a third of the first maximum current and the third maximum current.

15. The system of claim 14, in which the first LED light source is white; the second LED light source is green, the third LED light source is red, and the fourth LED light source is blue.

16. The system of claim 15, in which the integrated circuit further comprises a dimming signal circuit having a first dimming signal coupled to the first control circuit, a second dimming signal coupled to the second control circuit, a third dimming signal coupled to the third control circuit, and a fourth dimming signal coupled to the fourth control circuit; and the dimming signals being pulsed signals having a high signal level and a low signal level.

17. The system of claim 16, in which the dimming signal circuit further comprises input terminals configured to receive dimming input signals.

18. The system of claim 17, in which the dimming circuit is configured to receive dimming input signals from a color management circuit.
